(19) United States
(12) Patent Application Publication
(10) Pub. No.: US 2015/0221264 A1
(43) Pub. Date: Aug. 6, 2015

(54) LIQUID CRYSTAL DISPLAY DEVICE AND LIQUID CRYSTAL PANEL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: HAO WU, BEIJING (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 14/354,677

(22) PCT Filed: Apr. 16, 2013
(86) PCT No.: PCT/CN2013/074258

§ 371 Date: Apr. 28, 2014

(30) Foreign Application Priority Data
Feb. 1, 2013 (CN) 201310042149.1

(51) Int. Cl. G09G 3/36; G02F 1/1343; G09G 3/00; G02F 1/1368; G02F 1/1362; G02F 1/1335; G02F 1/133

(52) U.S. Cl. CPC G09G 3/3607; G02F 1/133514; G02F 1/134336; G02F 1/13318; G02F 1/1368; G02F 1/136286; G09G 3/006; G09G 3/3659; G02F 2001/134345; G09G 2320/0247; G09G 2300/0809; G09G 2300/0443; G09G 2310/0272; G09G 2310/027; G09G 2320/029

(57) ABSTRACT

There are disclosed a liquid crystal display device and a liquid crystal panel. The liquid crystal panel includes a color filter substrate (1) and an array substrate (2) that are disposed to be cell-assembled, and a drive unit. A plurality of sub-pixel units arranged in the form of matrix being formed on each of the color filter substrate (1) and the array substrate (2) in correspondence. A portion of the color filter substrate (1) corresponding to a display zone includes at least one photoelectric conversion device (11) for sensing a light intensity from the array substrate (2) and converting the light intensity to an induced current. The drive unit is configured to receive an induced current output by the photoelectric conversion device (11), and afterwards, to adjust a drive signal for a sub-pixel unit portion on the array substrate (2) in correspondence with the photoelectric conversion device according to the induced current and output it, so as to adjust a grayscale value of a corresponding sub-pixel unit. The array substrate (2) is configured to receive the drive signal of the drive unit, so as to drive a pixel electrode of the sub-pixel unit portion on the array substrate (2). The liquid crystal display device and the liquid crystal panel can reduce the possibility of occurrence of a phenomenon of picture flickering of the liquid crystal panel.

### FIELD OF THE INVENTION

The present disclosure relates to a liquid crystal display device and a liquid crystal panel.

### BACKGROUND

A Thin Film Transistor (briefly called as TFT) liquid crystal display device is one of liquid crystal display devices that are most common at present. Each liquid crystal pixel point of the liquid crystal display is driven by a thin film transistor. Thus, high-speed, high-brightness and high-contrast display of screen information can be realized by it, and then it gets the favor of the great mass of users.

Upon display with a liquid crystal panel in an existing liquid crystal display device, as uniformity of the screen of the liquid crystal panel is less, a phenomenon of picture flickering is relatively noticeable in general, which influences the viewing effect of users.

### SUMMARY

One of technical issues to be solved by the present disclosure is to provide a liquid crystal display device and a liquid crystal panel, for reducing the possibility of occurrence of a phenomenon of picture flickering of the liquid crystal panel, and improving the viewing effect of users.

According to an embodiment of the present disclosure, there is provided a liquid crystal panel, comprising a color filter substrate and an array substrate that are disposed to be cell-assembled, and a drive unit, with a plurality of sub-pixel units arranged in a form of matrix being formed on each of the color filter substrate and the array substrate in correspondence, wherein, a portion of the color filter substrate corresponding to a display zone includes at least one photoelectric conversion device for sensing a light intensity from the array substrate and converting the light intensity to an induced current; the drive unit is configured to receive the induced current output by the photoelectric conversion device, and adjust a drive signal for a sub-pixel unit portion on the array substrate in correspondence with the photoelectric conversion device according to the induced current and output it, so as to adjust a grayscale value of a corresponding sub-pixel unit; the array substrate is configured to receive the drive signal of the drive unit, so as to drive a pixel electrode of the sub-pixel unit portion on the array substrate.

In an example, each of the sub-pixel units is provided with one photoelectric conversion device.

In an example, the drive unit includes an analysis module and a drive module, and the analysis module is connected to photosensitive conversion devices of sub-pixel unit portions on the color filter substrate and the drive module; the analysis module is configured to receive, within a display period, induced currents of the photosensitive conversion devices, respectively, to analyses a relationship between a current value of each of the induced currents and a standard current value, and to send the analyzed results of the induced currents to the drive module; the drive module is configured to receive, within the display period, the analyzed results from the analysis module, and to adjust, at the beginning of the next display period, drive signals in correspondence to the induced currents, which are output to pixel electrodes of the sub-pixel units on the array substrate, according to the analyzed results.

In an example, the drive module is configured to adjust and output a drive signal for increasing the grayscale value of a corresponding sub-pixel unit on the array substrate at the beginning of the next display period, according to a difference between an induced current and the standard current value, upon the current value of the induced current being less than the standard current value; and to adjust and output a drive signal for decreasing the grayscale value of a corresponding sub-pixel unit on the array substrate at the beginning of the next display period, according to a difference between an induced current and the standard current value, upon the current value of the induced current being greater than the standard current value.

In an example, the color filter substrate includes a transparent substrate and a color-filter resin layer formed on the transparent substrate, and the photoelectric conversion device is disposed between the transparent substrate and the color-filter resin layer.

In an example, the photoelectric sensing device includes a gate line, a photoelectric thin film transistor and a data line, the gate line is an input end of the photoelectric sensing device; and the data line is an output end of the photoelectric sensing device.

In an example, the gate line of the photoelectric sensing device is connected to a gate line of the sub-pixel unit portion on the array substrate.

In an example, a gate line for controlling each of the sub-pixel units is provided on the array substrate, and position of the gate line of the photoelectric sensing device is opposed to position of the gate line of the array substrate.

In an example, a data line for transmitting the drive signal to each of the sub-pixel units is provided on the array substrate, and position of the data line of the photoelectric sensing device is opposed to position of the data line of the array substrate.

In an example, the photoelectric thin film transistor includes a photosensitive semiconductor, and material for the photosensitive semiconductor is cadmium sulfide.

In the technical solution of embodiments of the present disclosure, a portion of the color filter substrate in the liquid crystal panel in correspondence with a display zone has at least one photosensitive conversion device. Upon receiving light from the array-substrate-side, the photosensitive conversion device produces an induced current according to an intensity of the light and transmits the induced current to a drive unit. The drive unit outputs a drive signal to a pixel electrode of a sub-pixel unit portion on an array substrate based on the intensity of the induced current, so as to adjust the grayscale value of a corresponding sub-pixel unit. Thus, light emitted from every sub-pixel unit on the liquid crystal panel tends to be uniform, so that uniformity of the screen of the liquid crystal panel is improved, the possibility of occurrence of a phenomenon of picture flickering is reduced, and the viewing effect of users is enhanced.

According to another embodiment of the invention, there is provided a liquid crystal display device, comprising the liquid crystal panel as above.

### BRIEF DESCRIPTION OF THE DRAWINGS

In order to illustrate the technical solution of the embodiments of the invention more clearly, the drawings of the embodiments will be briefly described below; it is obvious that the drawings as described below are only related to some embodiments of the invention, but not limitative of the invention.

FIG. 1 is a structurally schematic view 1 illustrating a liquid crystal panel in an embodiment of the present disclosure;

FIG. 2 is a structurally schematic view 2 illustrating a liquid crystal panel in an embodiment of the present disclosure;

FIG. 3 is a structurally schematic view 3 illustrating a liquid crystal panel in an embodiment of the present disclosure;

FIG. 4 is a structurally schematic view illustrating a photoelectric thin film transistor in an embodiment of the present disclosure.

### DETAILED DESCRIPTION

In order to make objects, technical details and advantages of the embodiments of the invention apparent, hereinafter, the technical solutions of the embodiments of the invention will be described in a clearly and fully understandable way in connection with the drawings related to the embodiments of the invention. It is obvious that the described embodiments are just a part but not all of the embodiments of the invention. Based on the described embodiments of the invention, those ordinarily skilled in the art can obtain other embodiment(s), without any inventive work, which should be within the scope sought for protection by the invention.

Technical solutions provided by embodiments of the present disclosure are applicable to various TFT liquid crystal display devices, and especially applicable to an Advanced Super Dimension Switch (ADSDS) liquid crystal display device.

ADSDS is a relatively advanced technology for liquid crystal panels, in which, a multi-dimensional electric field is formed by an electric field produced at edges of slit electrodes within the same plane and an electric field produced between a layer of the slit electrodes and a layer of a plate-like electrode, so as to allow liquid crystal molecules with every alignment within a liquid crystal cell, which are located directly above the electrode and between the slit electrodes, to be rotated, and thereby the work efficiency of liquid crystals is enhanced and the transmissive efficiency is increased. Compared with other technology for liquid crystal panels, the picture quality of a thin film transistor liquid crystal display can be improved with ADSDS, which has merits of high resolution, high transmittance, low power consumption, wide viewing angle, high opening ratio, low chromatic aberration, Push Mura-free, etc.

### Embodiment 1

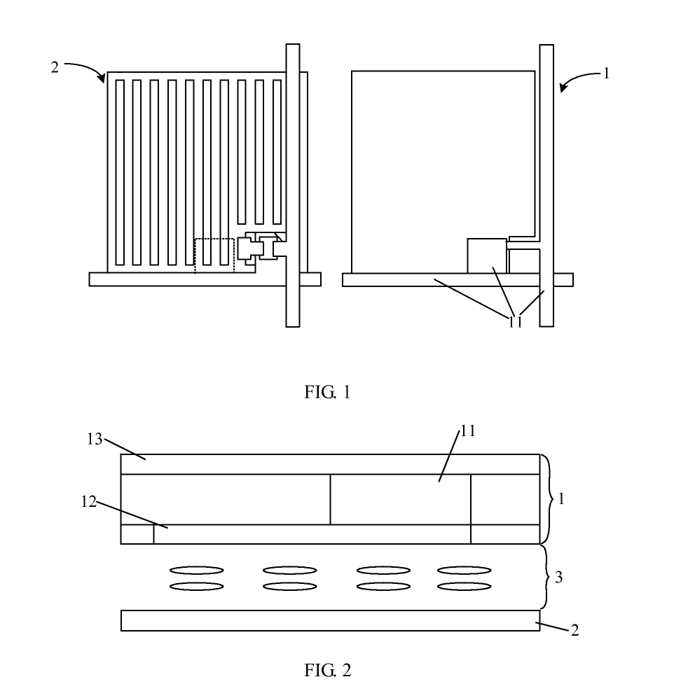

According to an embodiment of the invention, there is provided a liquid crystal panel, as illustrated in FIG. 1, comprising a color filter substrate 1 and an array substrate 2 that are disposed to be cell-assembled, and a drive unit. A plurality of sub-pixel units that are arranged in the form of a matrix are formed on each of the color substrate 1 and the array substrate 2 in correspondence.

A portion of the color filter substrate 1 in correspondence with a display zone includes at least one photoelectric conversion device 11, which acts to sense a light intensity from the array substrate 2 and convert the light intensity to an induced current. The drive unit is connected to the color filter substrate 1 and the array substrate 2, respectively. For example, the drive unit is configured to receive the induced current of the photoelectric conversion device 11, and to output a drive signal to each sub-pixel unit of the array substrate 2.

The drive unit is configured such that it receives the induced current output by the photoelectric conversion device 11, and then adjusts a drive signal for a sub-pixel unit portion on the array substrate 2 in correspondence to the portion of the display zone according to the induced current and output it, so as to adjust the grayscale value of a corresponding sub-pixel unit. That is, a drive signal for a sub-pixel unit portion on the array substrate 2 in correspondence to the photoelectric conversion device 11 is adjusted according to the induced current output by the photoelectric conversion device 11, so that grayscale value of a corresponding sub-pixel unit can be adjusted. For example, sub-pixel units of the color filter substrate 1 and the sub-pixel units of the array substrate 2 correspond to each other on a one-to-one basis, so that a photosensitive conversion device disposed in a certain sub-pixel unit on the color filter substrate 1 can detect a light intensity from a corresponding sub-pixel unit on the array substrate.

The array substrate 2 is configured to receive a drive signal of the drive unit, so as to drive a pixel electrode of the sub-pixel unit portion on the array substrate 2.

Specifically, as illustrated in FIG. 2, a liquid crystal layer 3 is filled between the color filter substrate 1 and the array substrate 2. Upon an image being displayed on a display zone of the liquid crystal panel, a potential difference lies between a common electrode and a sub-pixel electrode on the array substrate 2. Under the action of an electric field formed by the potential difference between the common electrode and the sub-pixel electrode, liquid crystals in the liquid crystal layer 3 are deflected. Thus, a light emitted from a backlight source under the array substrate 1 can pass through the deflected liquid crystal layer 3 to irradiate the color filter substrate 1, and in turn, it exits from a transparent, color filter resin layer 12 on the color filter substrate 1, allowing the displayed image to be seen by a user.

In an example, as illustrated in FIG. 1 or FIG. 2, each of the sub-pixel units is provided with one photosensitive conversion device 11. For example, a photosensitive conversion device 11 is provided within each of sub-pixel unit portions on the color filter substrate 1. Within a display zone, as light transmitted by the liquid crystal layer 3 irradiates the color filter substrate 1, it also irradiates the photosensitive conversion device 11 within the color filter substrate 1; and after the photosensitive conversion device 11 senses the light, it will produce an induced current, the value of which is in direct proportion to the intensity of the light, according to sensed intensity of the light, and output the induced current to the drive unit.

After receiving the induced current from each photosensitive conversion device 11, the drive unit adjusts a drive signal according to the value of the induced current and output it to a sub-pixel unit portion on the array substrate in correspondence to the portion of the display zone, so as to adjust the of potential of a pixel electrode of a corresponding sub-pixel unit portion on the array substrate 2, and then to adjust the grayscale value of the sub-pixel unit. Thus, light emitted from every sub-pixel unit on the liquid crystal panel tends to be uniform, so that uniformity of the screen of the liquid crystal panel is improved, the possibility of occurrence of a phenomenon of picture flickering is reduced, and the viewing effect of users is enhanced.

It is to be noted that, after the photosensitive conversion device 11 is added to the sub-pixel unit structure of the color filter substrate 1, the opening ratio of the liquid crystal panel might be reduced slightly. As illustrated by a schematic view of an array substrate 2 on the left side of FIG. 1, the dashed box is the projection of a photosensitive conversion device 11 on the array substrate 2 after a color filter substrate 1 and the array substrate 2 are cell-assembled.

In the technical solution of the embodiment, there is provided a liquid crystal panel, a sub-pixel unit portion on a color filter substrate in which has a photosensitive conversion device. Upon receiving a light from the array-substrate-side, the photosensitive conversion device produces an induced current according to an intensity of the light and transmits the induced current to a drive unit. The drive unit outputs a drive signal to a pixel electrode of a sub-pixel unit portion on an array substrate based on the intensity of the induced current, so as to adjust the grayscale value of a corresponding sub-pixel unit. Thus, light emitted from every sub-pixel unit on the liquid crystal panel tends to be uniform, so that uniformity of the screen of the liquid crystal panel is improved, the possibility of occurrence of a phenomenon of picture flickering is reduced, and the viewing effect of users is enhanced.

### Embodiment 2

According to an embodiment of the present disclosure, there is provided a liquid crystal panel. On the basis of Embodiment 1, the drive unit in the embodiment includes an analysis module and a drive module. The analysis module is connected to photosensitive conversion devices 11 of sub-pixel unit portions on the color filter substrate 1 and the drive module.

During display, an image signal is usually loaded to each sub-pixel unit in a line sequence manner, and the period in which all pixels on the liquid crystal panel are scanned through is referred to as a display period. Within one display period, the analysis module receives induced currents of the photosensitive conversion devices 11, respectively, analyses the relationship between a current value of each of the induced currents and a standard current value, and send the analyzed results of the induced currents to the drive module.

Since there are hundreds or thousands of sub-pixel units on each liquid crystal panel, after receiving the induced currents from the photosensitive conversion devices 11, the analysis module analyses the relationship between a current value of each of the induced currents and a standard current value.

For example, the analysis module analyses that each of the induced currents is greater than or less than the standard current value, and analyses what is the difference between each of the induced currents and the standard current value, namely, the analyzed result of each of the induced currents. Then, the analysis module sends the analyzed results of the induced currents to the drive module.

In an embodiment of the invention, a current value at a predetermined value may be set in advance as the standard current value (e.g. 0.2 mA), for the analysis use of the analysis module; also, the analysis module may also arbitrarily select the value of one of the induced currents as the standard current value (e.g. the value of an induced current for a pixel in a central zone), or compute the average value of all induced currents to serve as the standard current value, after it acquires all of the induced currents.

It is to be noted that, the method for acquiring the standard current value can be selected according to actual requirements, and embodiments of the present disclosure will not restrict this to any limits.

Within the display period, the drive module receives the analyzed results from the analysis module, and at the beginning of the next display period, adjusts drive signals in correspondence to the induced currents, which are output to pixel electrodes of sub-pixel units on the array substrate 2, according to the analyzed results.

For example, when the current value of an induced current is less than the standard current value, the drive module adjusts and outputs a drive signal for increasing the grayscale value of a corresponding sub-pixel unit on the array substrate 2 at the beginning of the next display period, according to a difference between the induced current and the standard current value; and when the current value of an induced current is greater than the standard current value, the drive module adjusts and outputs a drive signal for decreasing the grayscale value of a corresponding sub-pixel unit on the array substrate 2 at the beginning of the next display period, according to a difference between the induced current and the standard current value.

By means of adjusting a drive signal for a sub-pixel unit portion on the array substrate 2, the potential of a pixel electrode of sub-pixel unit portion on the array substrate is adjusted, so as to change the grayscale of the sub-pixel unit. In turn, the intensity of light emitted from the sub-pixel unit portion on the array substrate is changed, so that uniformity of the screen of the liquid crystal panel is improved, the possibility of occurrence of a phenomenon of picture flickering is reduced, and the viewing effect of users is enhanced.

For example, if the drive mode of the liquid crystal panel at this time is a normally black mode, then in the case that the value of an induced current corresponding to a certain sub-pixel unit is greater than the standard current value, it shows that the grayscale value of the sub-pixel unit is overhigh. In order to decrease the grayscale of the sub-pixel unit, it is required that at the next display period, the potential of a pixel electrode of the sub-pixel unit be reduced, so as to decrease a potential difference between the pixel electrode of the sub-pixel unit and a common electrode. Similarly, in the case that the value of an induced current corresponding to a certain sub-pixel unit is less than the standard current value, the potential of a pixel electrode of the sub-pixel unit then should be heightened.

If the liquid crystal panel is in a normally white mode, then when the grayscale value of a certain sub-pixel unit is overhigh, the potential of a pixel electrode of the sub-pixel unit should be heightened; similarly, when the grayscale value of a certain sub-pixel unit is too low, the potential of a pixel electrode of the sub-pixel unit should be reduced.

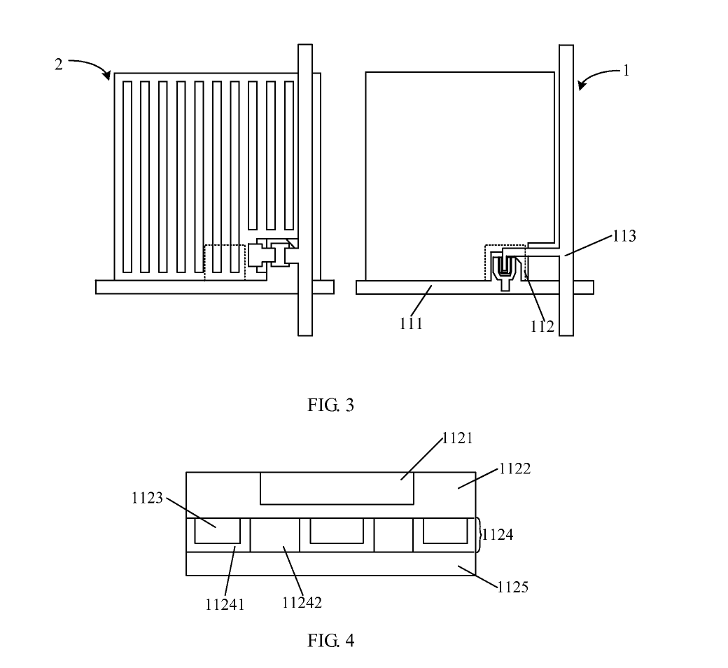

For example, as illustrated in FIG. 1, the photoelectric sensing device 11 is disposed between a transparent substrate 13 and a color-filter resin layer 12 of the color filter substrate 1; and as illustrated in FIG. 3, the photoelectric sensing device 11 includes a gate line 111, a photoelectric thin film transistor 112 and a data line 113. For example, as illustrated in FIG. 4, the photoelectric thin film transistor 112 sequentially includes from the transparent substrate to bottom: a gate layer 1121, a first insulating layer 1122, a source/drain electrode layer 1123, a semiconductor layer 1124 and a second insulating layer 1125, the semiconductor layer 1124 includes a photosensitive semiconductor 11241 and a semiconductor 11242 that are disposed alternately, and the photosensitive semiconductor 11241 is electrically connected to a source electrode and a drain electrode of the source/drain electrode layer 1123.

Further, the gate line 111 is an input end of the photoelectric sensing device 11; and the data line 113 is an output end of the photoelectric sensing device 11. That is, an input end of the analysis module is connected to the data line 113 of the photoelectric conversion device 11.

Gate lines for controlling the sub-pixel units are provided on the array substrate 2, and for example, they are connected to gate electrodes of thin film transistors in the sub-pixel units on the array substrate. Data lines for transmitting the drive signals (i.e. image signals for display) are further provided on the array substrate 2. The arrangement of the gate lines and the data lines will not be specifically limited by the present disclosure, and any suitable arrangement mode can be adopted. A gate line of the photoelectric sensing device 11 is connected to a gate line for a sub-pixel unit portion on the array substrate 2. Then, when the liquid crystal panel enters a display status, an electric level signal is received by the gate line for the sub-pixel unit portion on the array substrate 2. At this time, the electric level signal is received by the gate line 111 of the photoelectric sensing device 11, and then a semiconductor 11242 between photosensitive semiconductors 11241 gets conduction. In this case, resistance values of the photosensitive semiconductors 11241 decrease as the light intensity increases, and increase as the light intensity decreases, and then a current flowing between the photosensitive semiconductors 11241 and the semiconductor 11242 will change as the light intensity from the liquid crystal layer 3 side varies, i.e. an induced current. Here, the semiconductor 11242 acts to stabilize a current in the whole circuit, and its current is affected by the light intensity at a level far lower than the level at which the photosensitive semiconductors 11241 are affected, so as to avoid such a problem that resistances of the photosensitive semiconductors 11241 change too fast, which causes the current in the whole circuit to become unstable, and the accuracy of data acquisition is affected. Constituent ratios of the semiconductor 11242 and the photosensitive semiconductors 11241 may be adjusted according to an actual effect.

Thereafter, the induced current can flow out from the data line 113, and flow into the analysis module, so as to be analyzed by the analysis module.

It is to be noted that, a concrete structure illustrated in FIG. 4 of the photoelectric thin film transistor 112 proposed in an embodiment of the present disclosure is merely an example, and any structure is usable as long as it can fulfill the function of the photoelectric thin film transistor 112 proposed by the embodiment. The present disclosure will not restrict the specific structure of the photoelectric thin film transistor 112.

In order to prevent the opening ratio of a sub-pixel unit from being decreased further by the photoelectric sensing device 11, position of the gate line 111 of the photoelectric sensing device 11 is opposed to position of the gate line of the array substrate 2. That is, after the array substrate 2 and the color filter substrate 1 are cell-assembled, projection of the gate line 111 of the photoelectric sensing device 11 on the array substrate 2 coincides with the gate line of the array substrate 2 exactly, so that impact of the photoelectric sensing device 11 on the opening ratio of the sub-pixel unit is reduced.

Similarly, position of the data line 113 of the photoelectric sensing device 11 may also be opposed to position of a data line of the array substrate 2.

In the embodiment, material for the first insulating layer 1122 and the second insulating layer 1125 may be silicon nitride, or the like, material for the photosensitive semiconductors 11241 is, for example, cadmium sulfide, material for the gate layer 1121 and the source/drain electrode layer 1123 may be molybdenum, aluminum or other commonly used metal, and the semiconductor 11242 may be made with amorphous silicon.

According to an embodiment of the present disclosure, there is further provided a display device, comprising any of the above-mentioned liquid crystal panels. The display device may be: a liquid crystal panel, a cell phone, a tablet computer, a television, a display, a notebook computer, a digital photo frame, a navigator, or any product or component having a display function.

Specifically, the liquid crystal display device in the embodiment of the disclosure may include the liquid crystal panel illustrated in FIG. 1, FIG. 2 or FIG. 3.

The foregoing are merely exemplary embodiments of the invention, but are not used to limit the protection scope of the invention. The protection scope of the invention is determined by attached claims.

1. A liquid crystal panel, comprising a color filter substrate and an array substrate that are disposed to be cell-assembled, and a drive unit, with a plurality of sub-pixel units arranged in a form of matrix being formed on each of the color filter substrate and the array substrate in correspondence, wherein,
a portion of the color filter substrate corresponding to a display zone includes at least one photoelectric conversion device for sensing a light intensity from the array substrate and converting the light intensity to an induced current;
the drive unit is configured to receive the induced current output by the photoelectric conversion device, and adjust a drive signal for a sub-pixel unit portion on the array substrate in correspondence with the photoelectric conversion device according to the induced current and output it, so as to adjust a grayscale value of a corresponding sub-pixel unit;
the array substrate is configured to receive the drive signal of the drive unit, so as to drive a pixel electrode of the sub-pixel unit portion on the array substrate.

2. The liquid crystal panel according to claim 1, wherein, each of the sub-pixel units is provided with one photoelectric conversion device.

3. The liquid crystal panel according to claim 1, wherein, the drive unit includes an analysis module and a drive module, and the analysis module is connected to photosensitive conversion devices of sub-pixel unit portions on the color filter substrate and the drive module;
the analysis module is configured to receive, within a display period, induced currents of the photosensitive conversion devices, respectively, to analyses a relationship between a current value of each of the induced currents and a standard current value, and to send the analyzed results of the induced currents to the drive module;
the drive module is configured to receive, within the display period, the analyzed results from the analysis module, and to adjust, at the beginning of the next display period, drive signals in correspondence to the induced currents, which are output to pixel electrodes of the sub-pixel units on the array substrate, according to the analyzed results.

4. The liquid crystal panel according to claim 3, wherein, the drive module is configured to:
adjust and output a drive signal for increasing the grayscale value of a corresponding sub-pixel unit on the array substrate at the beginning of the next display period, according to a difference between an induced current and the standard current value, upon the current value of the induced current being less than the standard current value;
adjust and output a drive signal for decreasing the grayscale value of a corresponding sub-pixel unit on the array substrate at the beginning of the next display period, according to a difference between an induced current and the standard current value, upon the current value of the induced current being greater than the standard current value.

5. The liquid crystal panel according to claim 1, wherein, the color filter substrate includes a transparent substrate and a color-filter resin layer formed on the transparent substrate, the photoelectric conversion device is disposed between the transparent substrate and the color-filter resin layer.

6. The liquid crystal panel according to claim 1, wherein, the photoelectric sensing device includes a gate line, a photoelectric thin film transistor and a data line, the gate line is an input end of the photoelectric sensing device; and the data line is an output end of the photoelectric sensing device.

7. The liquid crystal panel according to claim 6, wherein, the gate line of the photoelectric sensing device is connected to a gate line of the sub-pixel unit portion on the array substrate.

8. The liquid crystal panel according to claim 7, wherein,
a gate line for controlling each of the sub-pixel units is provided on the array substrate, and position of the gate line of the photoelectric sensing device is opposed to position of the gate line of the array substrate.

9. The liquid crystal panel according to claim 7, wherein,
a data line for transmitting the drive signal to each of the sub-pixel units is provided on the array substrate, and position of the data line of the photoelectric sensing device is opposed to position of the data line of the array substrate.

10. The liquid crystal panel according to claim 5, wherein,
the photoelectric thin film transistor includes a photosensitive semiconductor, and material for the photosensitive semiconductor is cadmium sulfide.

11. A liquid crystal display device, comprising the liquid crystal panel according to claim 1.

12. The liquid crystal panel according to claim 2, wherein, the drive unit includes an analysis module and a drive module, and the analysis module is connected to photosensitive conversion devices of sub-pixel unit portions on the color filter substrate and the drive module;
the analysis module is configured to receive, within a display period, induced currents of the photosensitive conversion devices, respectively, to analyses a relationship between a current value of each of the induced currents and a standard current value, and to send the analyzed results of the induced currents to the drive module;
the drive module is configured to receive, within the display period, the analyzed results from the analysis module, and to adjust, at the beginning of the next display period, drive signals in correspondence to the induced currents, which are output to pixel electrodes of the sub-pixel units on the array substrate, according to the analyzed results.

13. The liquid crystal panel according to claim 2, wherein, the color filter substrate includes a transparent substrate and a color-filter resin layer formed on the transparent substrate, the photoelectric conversion device is disposed between the transparent substrate and the color-filter resin layer.

14. The liquid crystal panel according to claim 3, wherein, the color filter substrate includes a transparent substrate and a color-filter resin layer formed on the transparent substrate, the photoelectric conversion device is disposed between the transparent substrate and the color-filter resin layer.

15. The liquid crystal panel according to claim 4, wherein, the color filter substrate includes a transparent substrate and a color-filter resin layer formed on the transparent substrate, the photoelectric conversion device is disposed between the transparent substrate and the color-filter resin layer.

16. The liquid crystal panel according to claim 2, wherein, the photoelectric sensing device includes a gate line, a photoelectric thin film transistor and a data line, the gate line is an input end of the photoelectric sensing device; and the data line is an output end of the photoelectric sensing device.

17. The liquid crystal panel according to claim 3, wherein, the photoelectric sensing device includes a gate line, a photoelectric thin film transistor and a data line, the gate line is an input end of the photoelectric sensing device; and the data line is an output end of the photoelectric sensing device.

18. The liquid crystal panel according to claim 4, wherein, the photoelectric sensing device includes a gate line, a photoelectric thin film transistor and a data line, the gate line is an input end of the photoelectric sensing device; and the data line is an output end of the photoelectric sensing device.

19. The liquid crystal panel according to claim 5, wherein, the photoelectric sensing device includes a gate line, a photoelectric thin film transistor and a data line, the gate line is an input end of the photoelectric sensing device; and the data line is an output end of the photoelectric sensing device.

20. The liquid crystal display device according to 11, wherein, each of the sub-pixel units is provided with one photoelectric conversion device.
